(19) United States
(12) Patent Application Publication
(10) Pub. No.: US 2020/0340775 A1
(43) Pub. Date: Oct. 29, 2020

(54) Electromagnetic Coil-gun Launch Systems

(71) Applicants: Joshua Z. Zhou, San Jose, CA (US); Takyiu Liu, San Jose, CA (US)

(72) Inventors: Joshua Z. Zhou, San Jose, CA (US); Takyiu Liu, San Jose, CA (US)

(21) Appl. No.: 16/395,230

(22) Filed: Apr. 25, 2019

(51) Int. Cl. F41B 6/00; H01F 7/20; H01F 7/06

(52) U.S. Cl. CPC F41B 6/003; F41B 6/006; H01F 7/064; H01F 7/20

(57) ABSTRACT

An accelerator for a projectile includes a coil; an H-bridge coupled to the coil with four relays S1-S4, and a controller to control current flow in the coil, wherein when relays S1 and S4 are on and relays S2 and S3 are off, current goes through the coil in one direction, and when the states of the relays are switched, current direction reverses, wherein switching the current direction ensures that the projectile has a positive acceleration.

### BACKGROUND

This invention relates to electromagnetic guns and projectiles therefor.

Electromagnetic launchers are being developed because potentially achievable velocities of bodies in them are rather higher, than it can be received practically in typical thermodynamic guns. The achievement of very high velocity on electromagnetic launchers will help to solve many military, technical, commercial and scientific problems, such as earth-to-orbit launching of various designs and materials, removal of nuclear waste products, development of new materials and others.

One electromagnetic launcher type includes coilguns. They consist of one cylindrical coil or the array of coaxial cylindrical coils located sequentially one after another. The internal diameter of these coils forms the barrel of a launcher. Each coil is connected to the store of high-power energy, such as—inductive store, capacitor store, shock homopolar generator and others. As a rule, the metal cylinder is applied as an armature, which is considered as a short-circuited coil. The force of interaction between the armature and the coils of the launcher is increasing, if the current flowing in the coils of the launcher and in the armature is increasing. Large values of current and magnetic field in the coil result in many problems. The powerful magnetic field causes the large radial and axial forces that tend to compress the coil in axial direction and to increase the diameter in radial one.

### SUMMARY

An accelerator for a projectile includes a coil; an H-bridge coupled to the coil with four relays S1-S4, and a controller to control current flow in the coil, wherein when relays S1 and S4 are on and relays S2 and S3 are off, current goes through the coil in one direction, and when the states of the relays are switched, current direction reverses, wherein switching the current direction ensures that the projectile has a positive acceleration.

Advantages of the system may include one or more of the following. Coilguns can be used for commercial launch systems. The coilgun would propel a projectile with maximum velocity while also having a high power efficiency. The gun uses optimized parameters of every component of the system, including the coil, projectile, and power supply. In the system, electromagnetics, kinetics, and electrical circuit theory are employed to analytically describe the operations of a coilgun. Many coilgun design variations can be tested numerically to determine the optimal design. The analysis results are presented and measurements are utilized to verify the predictions of the designed coilgun.

### BRIEF DESCRIPTION OF THE DRAWINGS

FIGS. 1A-1B show exemplary electromagnetic launch systems.

FIG. 2 shows exemplary magnetic field and magnetic force acting on the projectile along the coil.

FIG. 3 shows exemplary change in polarity when the current switches directions.

FIG. 4 shows an exemplary RLC circuit.

FIG. 5A shows exemplary 3D and 2D plots of velocity depending on the start and stop points.

FIG. 5B shows exemplary 3D and 2D plots of power efficiency depending on the start and stop points.

FIG. 6 shows an exemplary three-stage coilgun.

FIG. 7 shows an exemplary diagram of the system

FIG. 8 shows exemplary sensors used in the system.

FIG. 9 shows exemplary predicted and measured currents.

FIG. 10 shows exemplary frequency of the three velocities.

FIG. 11A: shows exemplary five cases for the experiment.

FIGS. 11B-11E show exemplary predicted and measured results for the five cases

### DETAILED DESCRIPTION

Railguns and coilguns are the two most popular electromagnetic launch systems and use distinct methods to create an electromagnetic force and accelerate projectiles. A railgun consists of a power supply, rails, and a current-carrying projectile, as shown in FIG. 1A. The system is placed in an external magnetic field, and the current from the power supply flows through the rails and projectile. Thus, an electromagnetic force acts on the projectile, moving it along the rails. In contrast, a coilgun consists of a power supply, coil, and magnetic projectile, as shown in FIG. 1B. The current flows from the power supply through the coil, in which the projectile is placed. The solenoid generates a magnetic field, which accelerates the projectile.

The optimal coilgun would launch the projectile at a high velocity while requiring minimum power. The physics behind coilguns are not complicated. To facilitate this optimization, kinetics, electricity, and electromagnetism are employed to describe a coilgun's operations analytically, and different design variations can be analyzed numerically to determine the optimal system.

The coilgun consists of four components: a charged capacitor, which acts as the power source; a coil, which creates the magnetic field; a projectile; and a switch, which toggles the circuit between its on and off states.

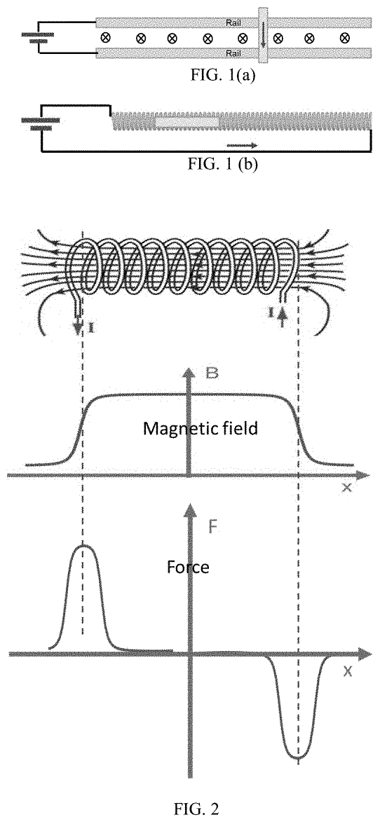

Major parameters of the coil are the coil radius R, coil length L, wire radius R_{wire}, and the number of turns N. The coil's inductance and resistance are also significant. As the current flows through the wire of the coil, a magnetic field is generated. This field can be expressed as an equation [2], as shown in Equation 1. A graph of this equation is shown in FIG. 2.

$$B ( x ) = \frac{{μ}_{0}}{4 π} \frac{2 π NI}{L} ⌈ \frac{x + L / 2}{\sqrt{{( x + L / 2 )}^{2} + {R}^{2}}} - \frac{x - L / 2}{\sqrt{{( x - L / 2 )}^{2} + {R}^{2}}} ⌉ \qquad Eq . 1$$

The coilgun utilizes a projectile that has a magnetic moment. In this paper, the projectile has a magnetic moment m. Additionally, the length of the projectile is Lₚ. When the projectile is placed in the magnetic field created by the solenoid, a magnetic force along the axis will act on the projectile. This force can be expressed as an equation [3], as shown in Equation 2. To simplify calculations, the derivative of the magnetic field can be estimated as the difference of the magnetic fields at the two ends of the projectile divided by the length of the projectile. A graph of Equation 2 is shown in FIG. 2. It is clear that the magnetic force acting on the projectile is non-zero only when the projectile moves through a non-uniform magnetic field.

$$F ( x ) = m \cdot \frac{d B}{dx} \approx m \cdot \frac{B ( x + \frac{{L}_{p}}{2} ) - B ( x - \frac{{L}_{p}}{2} )}{{L}_{p}} \qquad Eq . 2$$

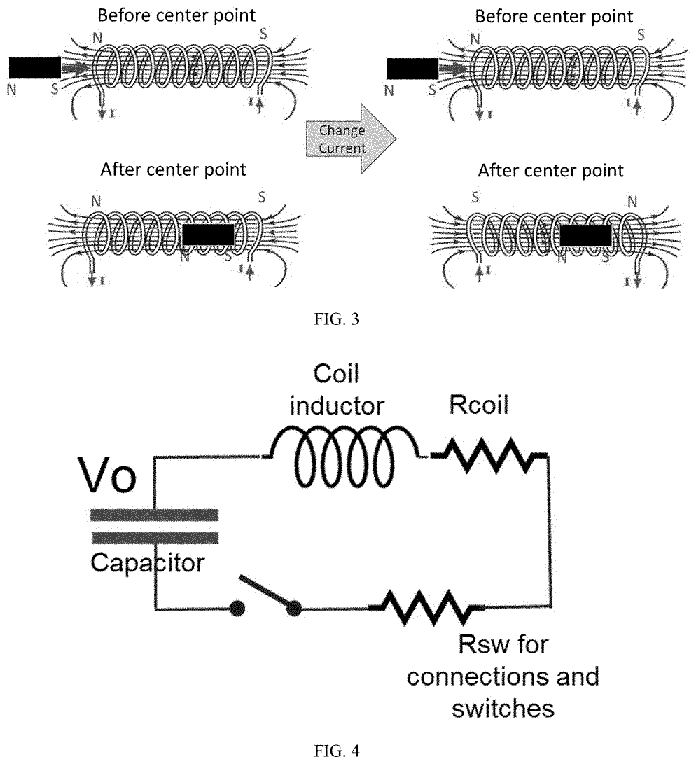

As the projectile enters the solenoid, the magnetic force acting on it increases to a maximum. At the center, the magnetic field is uniform, so the force is zero. As the projectile exits the solenoid, the force magnitude is also high. Thus, having a long coil does not increase the maximum velocity. In fact, the extra winding would increase resistance and dissipate more power. An optimal coil would minimize the center region without impacting the magnetic field near the two ends of the coil. Another important observation is that the directions of the force before and after the center point are opposites. Therefore, the projectile will accelerate in one region and decelerate in the other, which is not desired. To accelerate the projectile throughout the entire coil, the direction of the current must change when the projectile passes the center. When the current direction changes, the polarity of the solenoid also changes. Thus, the projectile will continue to experience an accelerating force after it passes the center, as shown in FIG. 3. In this analysis, it is assumed that the current changes direction when the projectile passes the center. Additionally, the friction between the projectile and coil needs to be considered. Friction is a constant force μ*M*g, where μ is the coefficient of friction and M is the mass of the projectile. In this analysis, μ is assumed to be 0.01.

Once the force on the projectile is known, the acceleration of the projectile at each point along the coil can be calculated using Newton's second law, as shown in Equation 3. Thus, the change in velocity is known, and the velocity at a certain point can be determined if the initial velocity v₀ is given, as shown in Equation 4.

$$\begin{matrix}a ( x ) = \frac{F ( x )}{M} & Eq . 3 \\ dv = a ( x ) d t = \frac{F ( x )}{M} * \frac{dx}{v} , {v ( x )}^{2} - {v}_{0}^{2} = 2 * {\int }_{{x}_{0}}^{x} \frac{F ( x )}{M} dx & Eq . 4\end{matrix}$$

Another major parameter is current, which is needed for the magnetic field equation, as shown in Equation 1. The coilguns are RLC circuits, as shown in FIG. 4. The current going through this type of circuit can be determined, as shown in Equation 5a. RLC circuits have different behaviors depending on their damping factor α/ω₀; however, the current can always be described analytically in all the cases. For the coilguns in this paper, the capacitance C is 120000 μF, the coil inductance L_{ind} is 40 μH, and the resistance R is about 0.2Ω. Therefore, the damping factor is 5.28. In these coilguns, the capacitance is large enough to store enough energy, and the coil inductance is too small to significantly impact the current. To simplify analysis, the effect of coil inductance on current will be ignored. The simplified coilguns are RC circuits that have a capacitor with an initial voltage V₀. The current can now more easily be described, as shown in Equation 5b. This simplification will be verified in the measurements later.

$$\begin{matrix}\frac{{d}^{2}}{{dt}^{2}} I ( t ) + 2 α \frac{d}{dt} I ( t ) + {ω}_{0}^{2} * I ( t ) = 0 \\ Where {ω}_{o} = \frac{1}{\sqrt{{L}_{i n d} * C}} , α = \frac{R}{2 {L}_{i n d}} & Eq . 5 a \\ I ( t ) = \frac{{V}_{0}}{R} {e}^{- \frac{t}{R C}} & Eq . 5 b\end{matrix}$$

The coilgun has a known coil design, and its projectile has known properties. The electrical characteristics of the coilgun, such as capacitance, resistance, and the initial voltage of the capacitor, are also known. The projectile can start from any point along the coil (This point will be called the start point.) The switches are then turned on, and current flows through the coil. The movement of the projectile can be divided into small steps Δx. The magnetic field, magnetic field change, magnetic force, projectile acceleration, and projectile velocity at each step can be determined. Using the velocity and distance Δx, the time taken to travel across each step, capacitor voltage at each step, and current in the coil at each step can be calculated. This calculation process can be repeated until the stop point, when the current is turned off.

Since the start point, stop point, and velocity at each point in between are known, t₁, the time taken for the projectile to reach the center point, and t₂, the time after the projectile has crossed the center, can be calculated. As mentioned previously, to maximize the projectile's final velocity, the direction of current during t₁ should be reversed during t₂. t₁, t₂, and the fact that the current switches direction when the projectile passes the coil's center determine the current profile. The current profile is critical in measuring a coilgun's performance.

Using the final projectile velocity v and the final capacitor voltage V, the final kinetic energy and the electrical energy dissipated, and the power efficiency can be calculated, as shown in Equation 6.

$$η = \frac{{E}_{kinetic}}{{E}_{electrical}} = \frac{\frac{1}{2} m {v}^{2}}{\frac{1}{2} C * ( {V}_{0}^{2} - {V}^{2} )} \qquad Eq . 6$$

This power efficiency equation can be plugged into mathematics software, such as Mathematica or Octave. The coil design parameters, such as length, radius, and number of turns, and projectile parameters, including mass and magnetic moment, can be varied. The start and stop points can also be changed. For each case, the initial and final capacitor voltages can be measured, and the final projectile velocity and power efficiency can be calculated. The small steps needed to determine the optimal start point, stop point, and current profile mean that millions of cases need to be analyzed. To limit this number, we're usually interested in two practical scenarios. One is to optimize the design and current profile of the coil for a specific projectile. The other is to find the optimal dimensions of the projectile and current profile of a fixed coil design.

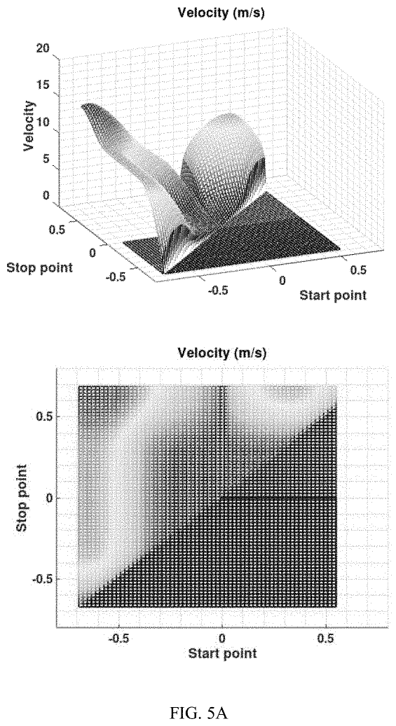

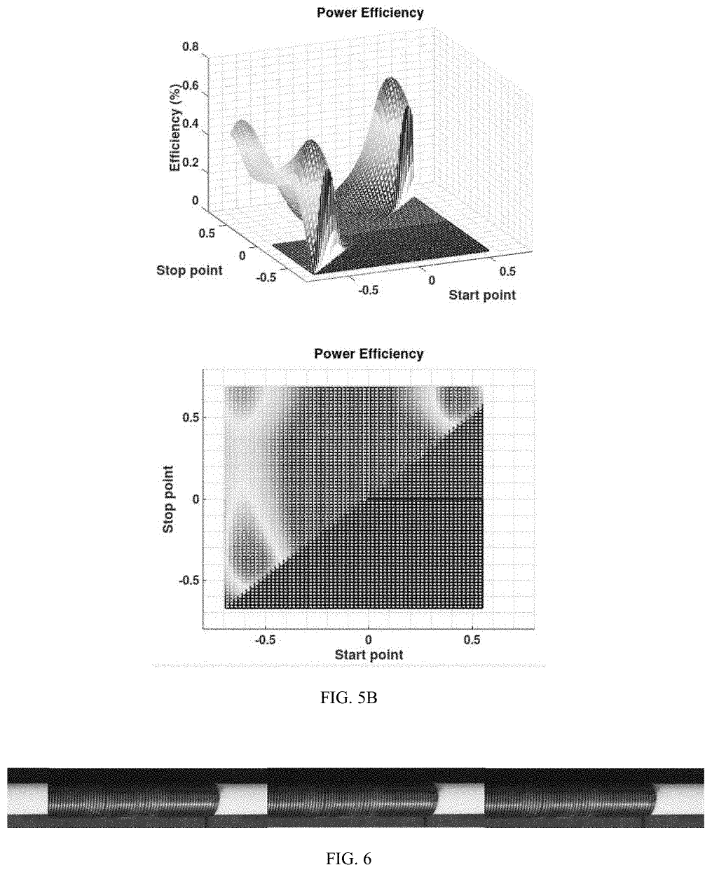

In the following example, the parameters of the coilgun and projectile are fixed, and the start and stop points (the current profile) needed to achieve the maximum velocity and power efficiency will be determined. The coil has a length of 50.8 mm (2 inches) and diameter of 7.8 mm. A gauge 22 copper wire is used for the coil winding. The magnetic projectile has a length of 12.7 mm (0.5 inch), diameter of 6.35 mm (0.25 inch), magnetic moment of 0.455 A*m² [4] and mass density of 7.5*10³ kg/m³. The magnetic moment and density listed are typical for N48 neodymium magnet projectiles with the same dimensions. The capacitor has a capacitance of 120000 μF and initial voltage of 48.5V. The resistance comes from two sources: the winding wire used for the coil and the connection wires. The latter has a resistance of 0.14Ω, which was found experimentally. It is assumed that the projectile starts from rest. Since all the required characteristics of the coil and projectile are known, different start and stop points can be tested to find the optimal pairing. At the start point x₀, the current is turned on. This current can be calculated since it is a capacitor discharging through a known resistance. Once the current is found, the magnetic field of the coil, magnetic force, projectile acceleration, and projectile velocity can also be determined. Thus, the projectile velocity at each point is known, and the power efficiency can be calculated. When the projectile reaches the stop point, the current is turned off. After, the projectile will experience a small frictional force before it leaves the coil and is launched. The results for the projectile's final velocity and the coilgun's power efficiency can be plotted, as shown in FIGS. 5a and 5b. In the graphs, the start and stop points are normalized by the coil length so that the plots are applicable to coils of different lengths. The origin is the center of the coil. Position −0.5 is the entrance of the coil, and position 0.5 is the exit of the coil. FIG. 5a shows that high velocities are achieved when the start point is either around positions −0.6 (outside the entrance of the coil) or 0.3 (between the center and exit of the coil). The maximum velocity is achieved when the start point is at position −0.7, which is outside the entrance of the coil, and the stop point is at position 0.7, which is outside the exit of the coil. From the experiment, the current was on for 5.77 ms (the time for the projectile to reach the center) before reversing and staying on for 2.77 ms (the time for the projectile to reach the stop point). Thus, the capacitor was discharging for a total of 8.54 ms.

FIG. 5B shows that high power efficiencies have different start and stop points. The highest power efficiency occurs in two situations. One situation is when the start point is at position −0.58 (outside the entrance of the coil) and the stop point at position −0.35 (between the entrance and center of the coil). The other situation is when the start point is at position 0.42 (between the center and exit of the coil) and the stop point at position 0.6 (outside the exit of the coil). These two situations occur at the two ends of the coil, where the magnetic field changes the quickest and the magnetic force is the highest. From the experiment, the total time that the current was on was only 1.99 ms, much shorter than the time needed to reach the maximum velocity. Overall, turning the current on in the most effective regions achieves the highest power efficiency.

In the measurements and analysis, it is assumed that the coils and projectiles used are for commercial use. This leads to the power efficiency below 1%, a very low number. There are many methods to improve the final projectile velocity and coilgun power efficiency. The resistance of the coil and connecting wires can be reduced to decrease power loss and increase the magnitude of current. One embodiment utilizes superconducting wires, which have zero resistance. Another method is to use better magnetic projectiles. For instance, if the magnetic moment of the projectile were doubled, the magnetic force on the projectile and the final velocity of the projectile would both be doubled. Therefore, the power efficiency would be quadrupled. Similarly, if the projectile's mass were halved, the power efficiency would quadruple too. The analytical process employed in this paper can be used for more advanced coils and projectiles.

A method to increase the projectile's final velocity is to utilize a multi-stage coilgun. FIG. 6 shows a coilgun with three coils. The main difference is that after the first coil, the initial projectile velocity for each coil after is not zero. Since the velocity is always increasing, the times required for the projectile to pass through the center of each coil are completely distinct. Thus, the optimal current profiles of each coil are also different.

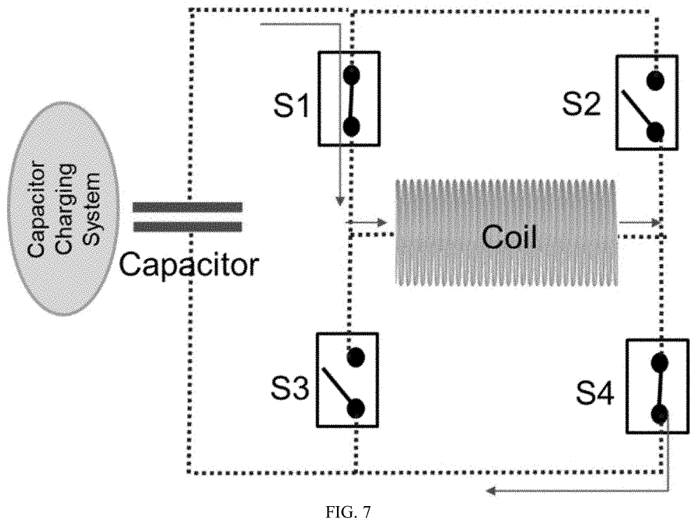

The goal of the following tests is to verify the analysis results. A diagram of the system is shown in FIG. 7. Most of the coil's and projectile's parameters are the same as above; the main differences are the coil length and projectile length.

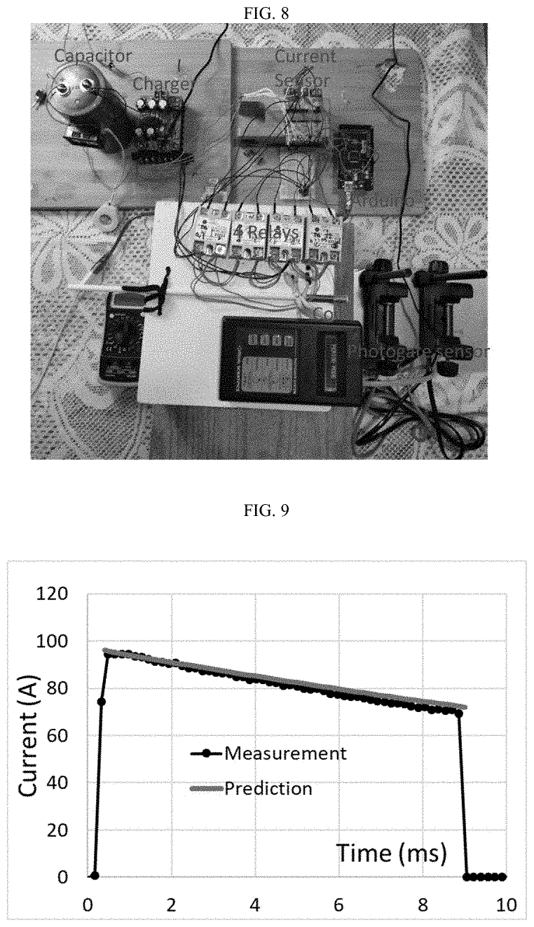

To switch the direction of the current when the projectile passes the center of the coil, an H-bridge configuration is utilized, as shown in FIG. 7 and FIG. 8. In this configuration, four solid-state relays are used. When relays S1 and S4 are on and S2 and S3 are off, the current goes through the coil in one direction; when the states of the relays are switched, the direction of the current reverses. As mentioned previously, switching the current direction ensures that the projectile always has a positive acceleration. To actively control the states of the relays in the H-bridge, an Arduino controller is employed. This Arduino system can be programmed to generate 5V piecewise-linear output signals, which are used to turn the solid-state relays on or off at precise times. To measure the current flowing through the coil, integrated linear Hall effect current sensors are employed. Since each current sensor can handle a maximum of only 20 A, multiple sensors are arranged in parallel to allow measurements of higher currents. These sensors generate digital signals that the Arduino system reads in to calculate the current. The final velocity of the projectile is measured with photogate sensors. These sensors detect the passing of the projectile and record the time of passing. By using two photogate sensors that are placed a known distance from each other, the velocity of the projectile can be calculated.

The coilgun system is an RLC circuit, and it can be simplified to an RC circuit. The goal of the following experiment is to verify this simplification. A coil with length 2 inches is used, and the total resistance of the system is measured to be 0.24Ω. Six Hall effect current sensors are placed in parallel, meaning that they can measure a maximum of 120 A. To lower the current to within this limit, the initial voltage of the capacitor is decreased to 24V. The predicted and measured currents are shown in FIG. 9. Within the time of interest, the current rises quickly before following an RC discharging behavior. The prediction and measurement are similar, and the simplification is verified.

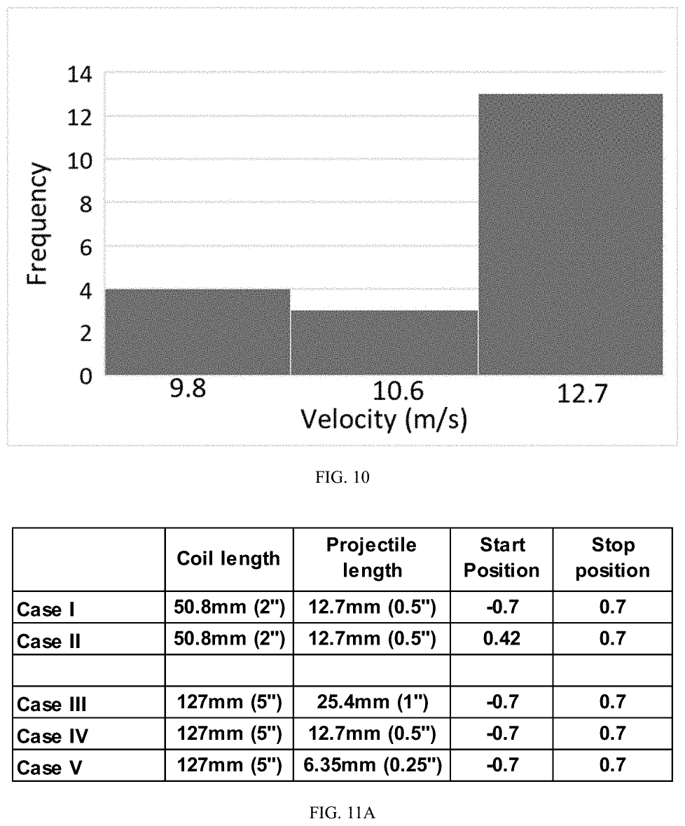

The next experiment is to verify the velocity measurement utilizing the photogate sensors. A coil of length 2 inches and a N48 magnet projectile of length ½ inch are used. The start and stop points used are the ones previously predicted to yield the maximum velocity. The same measurement is repeated twenty times. Three distinct velocities were observed, with the highest velocity, 12.7 m/s, appearing 65% of the time, as shown in FIG. 10. In our experiments, the most frequent velocity measurement is chosen. One reason for this is that the coilgun is not perfectly fixed and leveled, meaning that any small angle between the projectile trajectory and measurement regions of the photogate sensors will affect the measured values.

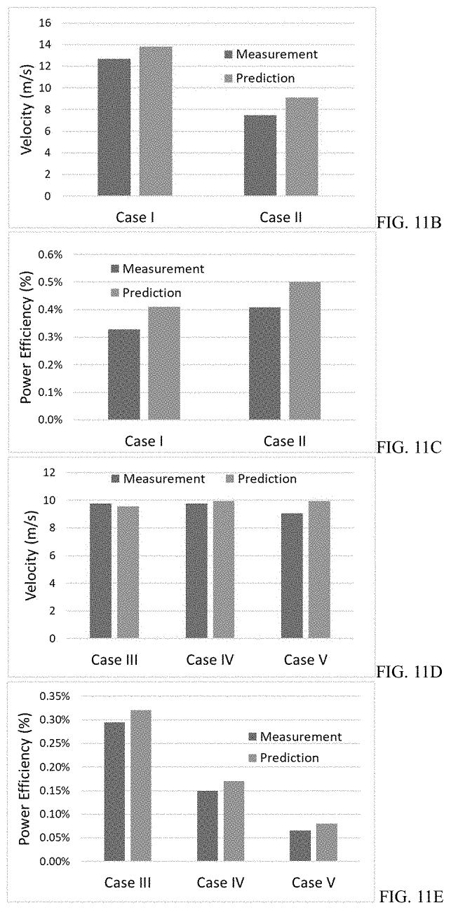

The goal of the final experiment is to verify the analysis results. In this experiment, two coils of lengths 127 mm and 50.8 mm and three N48 neodymium magnet projectiles of lengths 6.35 mm, 12.7 mm, and 25.4 mm, were utilized. Five cases, each with a different coil, projectile, start point, and stop point, were considered, as shown in FIG. 11a. For each case, the final projectile velocity and power efficiency were measured. These measurements were compared to the results from the analysis, as shown in FIGS. 11B-11E. The predicted and measured results are similar, meaning that the analysis is verified.

| | | | | | Start | Stop |
|---|---|---|---|---|---|---|
| | Coil length | | Projectile length | | Position | position |
| Case I | 50.8 | mm (2″) | 12.7 | mm (0.5″) | −0.7 | 0.7 |
| Case II | 50.8 | mm (2″) | 12.7 | mm (0.5″) | 0.42 | 0.7 |
| Case III | 127 | mm (5″) | 25.4 | mm (1″) | −0.7 | 0.7 |
| Case IV | 127 | mm (5″) | 12.7 | mm (0.5″) | −0.7 | 0.7 |
| Case V | 127 | mm (5″) | 6.35 | mm (0.25″) | −0.7 | 0.7 |

As detailed herein, electromagnetics, kinetics, and electric circuit theory are utilized to describe the operations of a coilgun. Important parameters of the coil, projectile, and power supply are considered, and the analysis is implemented into a mathematics tool. Coilguns with distinct parameters and designs can be tested numerically to find the optimal combination to achieve the maximum velocity or power efficiency. The results of the analysis and measurements are presented, and the comparisons show that the predictions are accurate. The method employed herein can be applied to more advanced coilgun designs, such as multi-stage coilguns, coilguns using superconducting wires, and coilguns utilizing projectiles with improved magnetic properties.

The present invention is not limited in its application to the details of construction and to the dispositions of the components set forth in the foregoing description or illustrated in the appended drawings in association with the present illustrative embodiments of the invention. The present invention is capable of other embodiments and of being practiced and carried out in various ways. In addition, it is to be understood that the phraseology and terminology employed herein are for the purposes of illustration and example, and should not be regarded as limiting.

As such, those skilled in the art will appreciate that the concepts, upon which this disclosure is based, may readily be utilized as a basis for the designing of other structures, methods and systems for carrying out the several purposes of the present invention. It is important, therefore, that the claims be regarded as including such equivalent constructions.

As one example, while the above illustrative embodiments include two non-magnetic, conductive rails which are insulated from the barrel, it is possible, that only a single rail may be used, with the barrel being used as the second rail. However, instead of the electric power source being connected to two rails, the electric power source would connect to the barrel and the single rail. The first sliding contact of the multi-turn coil would be in contact to the barrel instead of to a rail, while the second sliding contact would still be in connect with the rail, in order to simplify the design of the rail gun.

### INDUSTRIAL APPLICABILITY

The present invention is preferably applicable when a projectile is being accelerated to a hypervelocity, e.g., launching a projectile to outer space or launching a projectile intercontinentally.

Although the present invention has been described herein with respect to a number of specific illustrative embodiments, the foregoing description is intended to illustrate, rather than to limit the invention. Those skilled in the art will realize that many modifications of the preferred embodiment could be made which would be operable. All such modifications, which are within the scope of the claims, are intended to be within the scope and spirit of the present invention

What is claimed is:

1. An accelerator for a projectile, comprising:
a coil;
an H-bridge coupled to the coil with four relays S1-S4, and
a controller to control current flow in the coil, wherein when relays S1 and S4 are on and relays S2 and S3 are off, current goes through the coil in one direction, and when the states of the relays are switched, current direction reverses, wherein switching the current direction ensures that the projectile has a positive acceleration.

2. The accelerator of claim 1, wherein the relays are solid state relays.

3. The accelerator of claim 1, wherein the controller generates piecewise-linear output signals, which are used to turn the solid-state relays on or off at precise times.

4. The accelerator of claim 1, comprising linear Hall effect current sensors coupled to the controller to detect current flowing through the coil.

5. The accelerator of claim 4, wherein the current sensors are arranged in parallel.

6. The accelerator of claim 1, comprising photogate sensors to detect projectile velocity.

7. The accelerator of claim 1, comprising two photogate sensors coupled to the controller and placed a predetermined distance from each other to determine projectile velocity.

8. The accelerator of claim 1, wherein the accelerator is modeled as a resistive, inductor, capacitance (RLC) circuit.

9. The accelerator of claim 1, comprising superconducting wires with zero resistance.

10. The accelerator of claim 1, wherein the projectile comprises one or more magnetic projectiles.

11. A method to accelerate a projectile, comprising:
applying currents to a coil using an H-bridge coupled to the coil with four relays S1-S4, and
controlling current flow in the coil, wherein when relays S1 and S4 are on and relays S2 and S3 are off, current goes through the coil in one direction, and when the states of the relays are switched, current direction reverses, wherein switching the current direction ensures that the projectile has a positive acceleration.

12. The method of claim 11, wherein the relays are solid state relays.

13. The method of claim 11, wherein the controller generates piecewise-linear output signals, which are used to turn the solid-state relays on or off at precise times.

14. The method of claim 11, comprising applying linear Hall effect current sensors coupled to the controller to detect current flowing through the coil.

15. The method of claim 11, wherein the current sensors are arranged in parallel.

16. The method of claim 11, comprising photogate sensors to detect projectile velocity.

17. The method of claim 11, comprising two photogate sensors coupled to the controller and placed a predetermined distance from each other to determine projectile velocity.

18. The method of claim 11, wherein the accelerator is modeled as a resistive, inductor, capacitance (RLC) circuit.

19. The method of claim 11, comprising superconducting wires with zero resistance.

20. The method of claim 11, wherein the projectile comprises one or more magnetic projectiles.
